(19) United States
(12) Patent Application Publication
(10) Pub. No.: US 2014/0076939 A1
(43) Pub. Date: Mar. 20, 2014

(54) BAMBOO CLOTHES HANGER

(71) Applicant: William CHOI, Palisades Park, NJ (US)

(72) Inventor: William CHOI, Palisades Park, NJ (US)

(21) Appl. No.: 13/621,913

(22) Filed: Sep. 18, 2012

(51) Int. Cl. A47G 25/14; B27M 1/00

(52) U.S. Cl. 223/85; 144/344

(57) ABSTRACT

The present invention provides a garment hanger comprising a hook attached to a central region of a support arm structure wherein the support arm is a section of bamboo having a first end and a second end and further comprising a bend where in the bend has a predetermined radius.

### BACKGROUND OF THE INVENTION

1. Field of Invention

The present invention relates to a garment hanger, and more particularly, to garment hangers having a frame constructed of natural ecologically friendly materials, more particularly constructed of bamboo.

2. Description of the Related Art

It is known to utilize hangers to hold clothing in a free hanging manner in order to minimize wrinkles and damage to the fabric, especially for garments that have been laundered or cleaned in order to preserve the freshly pressed appearance and characteristics of the fabric.

A typical type of clothing hanger is constructed of bent wire, which is shaped in such a manner to provide a support for many types of garments in a manner that replicates the way the garment is worn. Clothing hangers have typically utilized a shape which simulates a person's upper torso, including a person's neck and shoulders.

A typical prior art wire hanger shape is triangular with a hook located at the top for attaching the hanger to a pole, two downward sloping support arms, that simulate the shape of a person's shoulders and a base section between each of the support arms that provides structural rigidity to the two downward sloping members.

Wire or metal hangers, however, tend to lack strength to support heavy or bulky garments such as jackets or coats, and bend due to weight. This can be especially true for garments that are wet and are hung on a hanger to dry as a wet garment can weigh substantially more than a similar dry garment. Additionally, due to the lack of strength of a wire hanger, they can be easily deformed by simply hanging or removing a garment, and thus lose their capacity to properly support a garment, therefore causing the garment to fall off the hanger or become wrinkled due to the deformed shape of the hanger. Also, because of their weak structure, they are easily deformed and thus cannot be readily reused, thus increasing the costs for end users and businesses such as dry cleaners in that the hangers must be replaced. Further, because the metal hangers are coated with toxic materials, they cannot be reused. Moreover, because of the weak structure and tendency to become deformed, there are environmental costs and ramifications to using wire hangers in that they are not adaptable to reuse or recycling. Furthermore, the storage of conventional metal and plastic hangers used in residential and commercial tend to be bulky and wasteful as they can easily be deformed and damaged. For suppliers, the bulky packaging containing the metal and plastic hangers adds more cost.

Additionally, wire hangers typically require a coating that must be applied to prevent oxidation of the wire which could damage the garment fabric. However, the coating, which may for example be paint, requires an additional manufacturing step to apply and still may not provide complete protection for the garment. The coating can be worn or scratched off with continual and repeated use, thus leaving the exposed wire subject to environmental factors such as moisture which can cause oxidation and thus may ruin a garment hung on the hanger. The moisture can also be generated during storage when the garments are hung with a plastic cover in a closet. Additionally the coating may itself damage a garment by being rubbed or worn off by the garment, especially if the garment is damp or wet, thus discoloring or otherwise damaging the garment. Wire hangers also lack pleasing esthetics, as they are typically made from a single thin wire that can be deformed, scratched or oxidized.

Other types of hangers are also manufactured and used, such as wood or plastic. However, these hangers also have drawbacks. Wood hangers require extensive manufacturing processes to cut, shape, polish and assemble the wooden pieces to ensure a shape that can hold a garment without introducing wrinkles, folds or puckers. Additionally, the wooden hangers also require a protective coating or painting to protect the user and garments from splinters or discoloration due to contact with the wood. Plastic hangers also require an advanced and complicated production process to mold the plastic into the appropriate shape that will hold a garment in a flat wrinkle free position, while also ensuring adequate strength and durability.

### SUMMARY OF THE INVENTION

It is therefore an objective of the present invention to provide a hanger that is stronger and can resist bending, is environmentally friendly, does not require any coatings or painting and can be easily re-used, stored with less space and recycled.

It is, therefore a further objective of the present invention to provide a hanger that reduces undesirable deformation of garments retained by the hanger.

It is another objective of the present invention to provide an improved hanger, which can be economically manufactured to provide an improved performance of the hanger by contacting and supporting the collar area of a garment such as a shirt for example, with the hanger frame to prevent deformation of the body of the hanged garment.

It is another objective of the present invention to prevent wrinkles, creases, puckers or bumps in the garment that is supported on a hanger, especially in the shoulder region of the garment.

It is another objective of the present invention to provide a hanger that has an esthetically pleasing and natural appearance.

It is a further objective of the present invention to provide a frame having smooth curved support arms to prevent puckers or bumps in the shoulder of a garment disposed on the inventive hanger.

It is a further objective of the present invention to provide a simple method of making a hanger from a natural material, such as bamboo.

There is therefore provided a garment hanger comprising a hook attached to a central region of a support arm structure wherein the support arm is a section of bamboo having a first end and a second end and further comprising a bend where in the bend has a predetermined radius.

There is therefore further provided a method for making a garment hanger, the method comprising: providing a section of bamboo, heating the section of bamboo, bending the section of bamboo to a predetermined angle, allowing the section of bamboo to cool; and attaching a hook to the section of bamboo.

### BRIEF DESCRIPTION OF THE DRAWINGS

The above and other exemplary aspects, features and advantages of certain exemplary embodiments of the BAMBOO CLOTHES HANGER according to the present invention will become more apparent to a person or ordinary skill in the art from the following detailed description taken in conjunction with the accompanying drawings, in which:

FIG. 1 is a front perspective view of the inventive hanger according to an embodiment of the present invention;

FIG. 1A is a front perspective view of a section of the inventive hanger according to an alternate embodiment of the present invention;

FIG. 2 is a front view of the inventive hanger according to an embodiment of the present invention;

FIG. 3 is a rear view of the inventive hanger according to an embodiment of the present invention;

FIG. 4 is a view of one side of the inventive hanger according to an embodiment of the present invention;

FIG. 5 is a view of an opposite side of the inventive hanger according to an embodiment of the present invention;

FIG. 6 is a top view of the inventive hanger according an embodiment of the present invention; and

FIG. 7 is a front perspective view of the inventive hanger according to an alternate embodiment of the present invention.

### DETAILED DESCRIPTION

Exemplary embodiments of the present invention will now be described herein below with reference to the accompanying drawings. In the following description, well-known functions or constructions may not be described in detail when they would obscure appreciation of the present invention by a person of ordinary skill in the art with unnecessary detail of the well-known functions and structures. Also, the terms used herein are defined according to the functions of the present invention as would be understood by a person of ordinary skill in the art. Thus, the terms may vary depending on user's or operator's intention and usage. That is, the terms used herein must be understood based on the descriptions made herein in view of the ordinary level of skill in the art. In all figures, the substantially same elements are given the same reference number, and overlapping descriptions are omitted.

The present invention described hereinafter provides a clothes or garment hanger of improved design that provides bamboo frame having a curved support frame and a hook for hanging the hanger from a pole. The curved support frame provides a smooth surface for supporting a garment for reducing deformation and thus minimizing wrinkles and garment damage. The hanger according to the present invention provides support arms that are constructed of a single piece of bamboo, that is curved to have a consistent smooth radius that is also structurally strong and provides a uniform support structure for the retained garments. The hanger according to the present invention may be made according to the method of applying heat to a section of bamboo and using mechanical means to simultaneously deform the bamboo into a curved section having a predetermined angle of bend and radius. The bamboo section, then according to the characteristics of the bamboo material will retain its desired shape upon cooling without the need for any other structural supports or devices. Additionally, the bamboo according to the present invention will have an even textured and polished surface without the need for any coating, sanding or treatment.

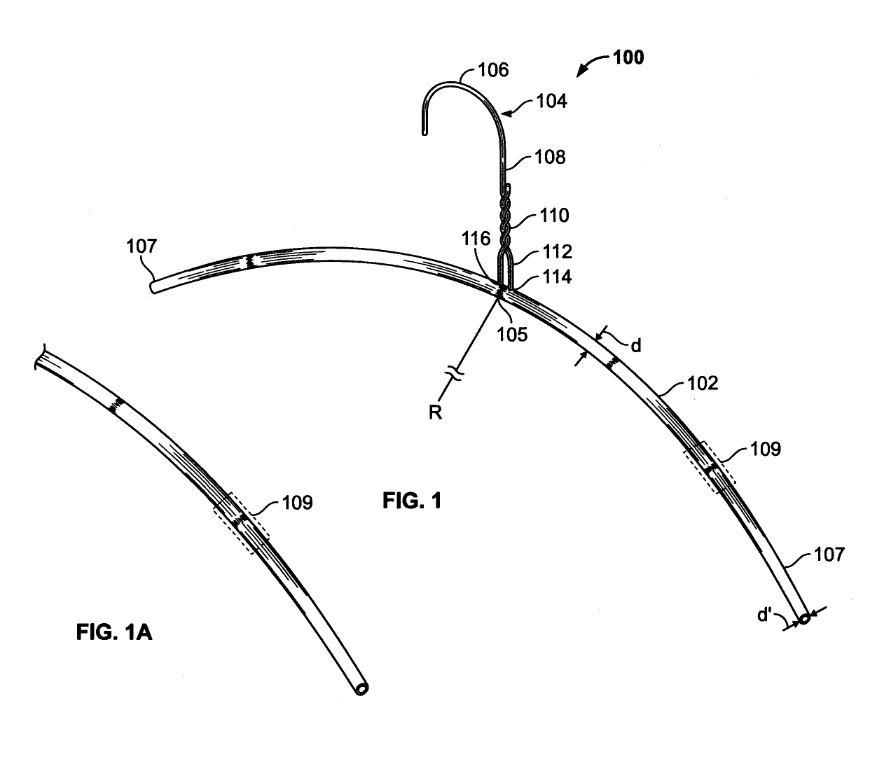

FIG. 1 is a front perspective view of the inventive hanger 100 according to an embodiment of the present invention. The hanger depicted in FIG. 1 is manufactured of a single piece of bamboo section that is bent into a curved section having a predetermined radius to form the support arms 102. The hanger 100 generally includes a hook 104 which may be formed of a piece of wire that can be inserted through holes at the middle section 105 of the support arm and then bent to have a semicircular portion 106 for suspending the hanger on a horizontal rod at one end of the piece of wire. The hook 104 has a neck 108 which attaches to the support arms 102 of the hanger. The neck 108 includes a twist of wire 110 to secure the neck 108 to a diverging support section 112. The vertical diverging support section 112 is formed from bends in the wire. The hook 104 is attached to the support arms 102 by a passing the ends of the vertical diverging support section 112 through a first hole 114 and second hole 116 in the support arms and then bent in an outward or inward direction along the support arms to form a tab under the support arms and attach the hook 104 to the support arms 102. While the attachment of the hook 104 is described in a particular manner, this description is only exemplary of one particular embodiment. Those skilled in the art will recognize that other means of attaching the hook are possible within the scope of the invention. For example, the hook may be glued to the support arms without departing from the spirit and scope of the invention. Further, the initial raw bamboo materials may be subject to a treatment to remove the moisture therefrom.

The support arm 102 is constructed of a single section of bamboo, which has a length prior to bending of between A and B, and most preferably between 18 to 22 inches. Although one skilled in the art will recognize that the length of the straight section can be varied depending on the intended garments for which the hanger is going to be used. For example, for larger bulky garments such as winter outerwear, a longer section may be used to provide a longer support section. Additionally, to provide a particular stiffness to the support arms the diameter d of the support arms may be varied in accordance with the needs of the user. Similarly to varying the section length, the diameter may be increased to add structural strength for heavier garments and made thinner for lighter garments such as shirts or blouses. The diameter d may be between A and B, and most preferably between 0.25 to 0.5 inch. The support arms 102 may also be tapered towards the outer ends 107 such that the diameter d′ is smaller at the outer ends 107, than d at the middle section 105.

The clothing hanger 100 is generally semicircular in shape having a predetermined radius R, which may be varied depending on the intended use for the hanger. The garment support arms 102 typically may be used for hanging and supporting a garment such as a shirt or blouse, however the hanger according to the present invention is not so limited and may be used for any similar outerwear such as, but not limited to a jacket, sweater or coat. The garment support arms 102 provide the section of the hanger where a garment is placed and supported. In order to minimize the wrinkling of a garment hanging from the hanger according to the present invention, the angle of the bend of the garment supporting sections where the garment is draped are selected such that the front and back garment surfaces will be substantially flat when the garment is placed on the hanger, without any folds or overlapping of the fabric. The angle of the bend may vary depending on the type of garment for which the hanger will be used. For example the bend may be between 20 to 35 degrees. The rounder, (more bend, smaller radius) hanger is preferable for jackets and coats, while a flatter (less bend, larger radius) provides less wrinkles when hanging shirts or other similar garments. However, one skilled in the art will recognize that other bend angles may be used depending on the size and weight of the clothing being hung. Additionally, as shown in FIG. 1A, the hanger according to the present invention may also incorporate a support arm 102 having a varying angle. For example, the support arms may have one radius in the central section 105, and transition to a larger or smaller radius section toward the outer section 107. In this way, the hanger according to the present invention may be adapted to be more appropriately shaped for various garments. For example, the hanger may have downward sloping outer sections 107 in order to have a more rounded end support sections. This can be especially beneficial for hanging fabrics that are susceptible to puckering or stretching. Thus, the shape of the outermost ends of the downward sloping garment support arms 107 may be selected to minimize or eliminate deformation of the garment supported at the outermost ends. Thus, the angles of the garment support arms 102 may be selected to provide uniform and consistent support to the garment consistent with the garment shape, size and weight. Further, the hanger 100 is provided with a support material 109 at both ends thereof which may be made of rubber, Styrofoam, spongy type or other materials to hold against the clothing suspended thereon in place so that the fabric does not stretch around the shoulder area due to gravity.

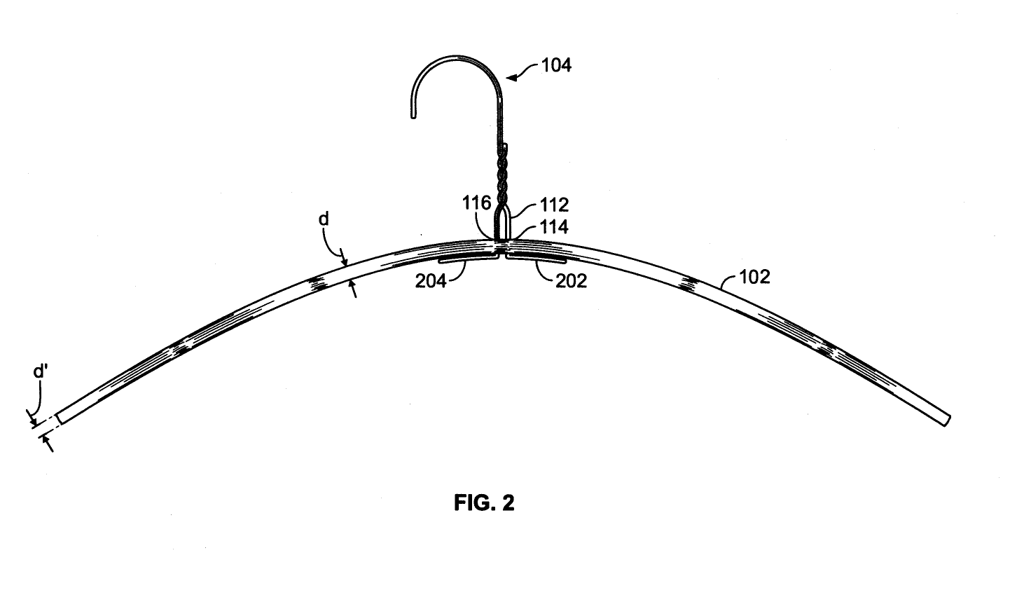

Turning now to FIG. 2, there is shown a front view of the inventive hanger according to the embodiment of the present invention depicted in FIG. 1. As described in FIG. 1 and more clearly depicted in FIG. 2 there is shown the ends of the vertical diverging support section 112 through a first 114 and second hole 116 in the support arms and then bent in an outward or inward direction along the support arms to form a tab 202 and 204 under the support arms and attach the hook 104 to the support arms 102. Additionally, there is depicted support arms 102 which may also be tapered towards the outer ends 107 such that the diameter d′ is smaller at the outer ends 107, than d at the middle section 105.

Furthermore, as described above, there is more clearly depicted in FIG. 2 the angle 206 of the bend for the curved support arm 102. While one particular angle of bend and curve is depicted, the angle and curve may vary depending on the type of garment for which the hanger will be used. For example the bend may be between 20 to 35 degrees. As The rounder, (more bend, smaller radius) hanger is preferable for jackets and coats, while a flatter (less bend, larger radius) provides less wrinkles when hanging shirts as the larger radius, (flatter support arms) provide a wider support structure for the shirt or similar garment and thus minimize folds and wrinkles

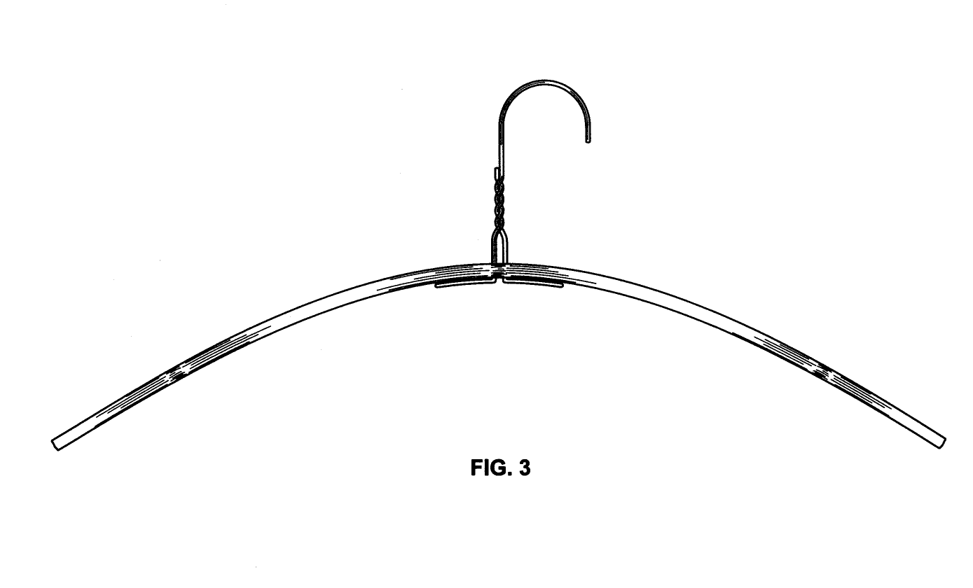

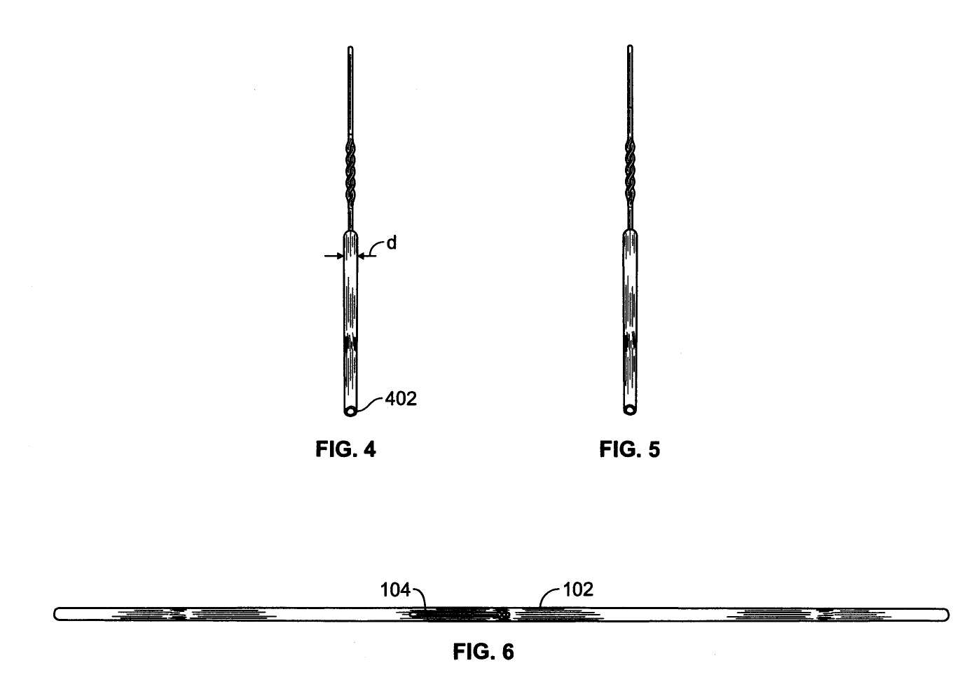

Turning now to FIG. 3, there is shown a rear view of the inventive hanger according to the embodiment of the present invention depicted in FIG. 1. As described in FIG. 1, there is shown a reverse side view of hook 104. Similarly, FIGS. 4 and 5 depict side views of view of the inventive hanger according to the embodiment of the present invention depicted in FIG. 1. Also, as can be seen in FIGS. 4, and 5, outer ends 107 are substantially circular in cross section, consistent with the shape of bamboo. Additionally, as described above, outer ends 107 may be tapered such that the cross section diameter 402 may be smaller than the diameter d of the support arms 102 in the central section of the support arm 102.

FIG. 6 is a top view of the inventive hanger according an embodiment of the present invention depicted in FIG. 1. FIG. 6 depicts the support arms 102 and hook 104. As shown in FIG. 1 the support arm 102 is a single piece of bamboo section that is bent into a curved section having a predetermined radius to form the support arms 102, with hook 104 extending above the support arm for attaching the hanger to a horizontal pole.

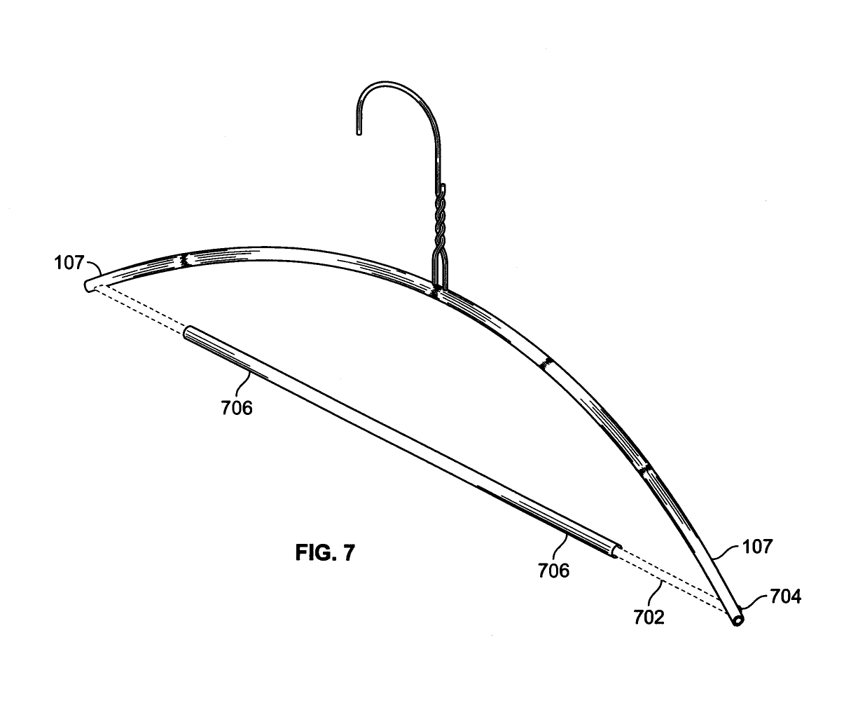

Turning now to FIG. 7, there is shown a side perspective view of hanger 100. In this view there is shown an alternate embodiment having an additional support structure located between outer ends 107. The additional support structure 702 may include any type of material for providing a connection or support between the outer ends 107. This support may include a bamboo section, string, cardboard or wire section. This support may be affixed by attaching the support 702 to the outer ends. In one particular embodiment, for a string or wire support, the support 702 may be attached to the out ends 107 by inserting the string or wire through a first hole placed in the outer ends 107 and then looped through a second hole in the outer end. Thus a loop 704 will serve as an attachment at one outer end 107 and a similar loop (not shown) at the other outer end will serve to attach the support to the other out end 107. The string or wire may hold a tubular element 706 extending across the support 702 from one outer end to the other outer end 107. In this way the hanger according to the present invention may be adapted to also serve as a garment hanger for pants or other similar garment that may be draped across the tubular element 706. Additionally, the support 107 need not hold a tubular element or any other garment holding device, but may simply be adapted to provide additional structural support by holding the outer ends 107 in tension and thus providing additional stiffness to the hanger outer ends 107 by holding them in taught condition and connected to each other. Further, a paper cover (not shown) wrapping around the hanger can be implemented to display logos thereon for advertisement purposes.

The hanger according to the present invention may be constructed according to the method of applying heat to a section of bamboo and using mechanical means to simultaneously deform the bamboo into a curved section having a predetermined radius. For example, a hot pressing or a molding (not shown) having the desired bamboo shape shown in FIGS. 1 through 3 can be used. In the formal, a base having the inventive angle can be applied to the bamboo via hot pressing at the temperature. In the latter, a bamboo can be inserted into a mold having the inventive configuration and heated to a specific temperature. A bamboo section maybe cut to the usable length and then curved or may be curved in longer sections and then cut to length. In order to create the curve, the bamboo sections are heated to a predetermined temperature and then bent using mechanical means such as a mandrel, press or other type of bender. Due to the low force necessary, the bamboo can even be curved by using hand tools. The bamboo may typically be heated to a temperature within the range of 752 through 1472 degrees Fahrenheit (or 400 to 800 Celcius). The bamboo section is then held in the curved position by the mechanical means utilized while cooling. The mechanical bending process may typically be maintained for a period time ranging from about 15 to 20 seconds, and most preferably for a time period of about 20 seconds. One skilled in the art will recognize that the temperature range and the time interval utilized can vary depending on factors such as for example, the diameter of the bamboo, the bamboo section length and the moisture content of the bamboo. Upon cooling, according to the characteristics of the bamboo material it will then retain the curved shape applied during the bending process without the need for any other structural supports or devices. Additionally, the bamboo according to the present invention will have an even textured and polished surface without the need for any coating, sanding or treatment.

In alternate embodiment, both arms of the hanger can be tied with a metal wire, fishing wire, or other string strong enough to hold the both ends of arm of the hanger to have the desired shape without the heat application.

According to the present invention, bamboo provides many advantages as a material for use as a hanger support arm. Bamboo is a renewable, sustainable resource that provides a cheap and fast-grown resource with superior physical and mechanical properties to wood and in some regards to steel. Additional uses for bamboo encourage the development of this renewable resource over other non-renewable resources such as steel or plastics. In addition, the production of bamboo relies on the natural process of growing the plant, which is more environmentally friendly the processes needed to produce wire or plastics for use in hangers. Furthermore, studies have shown and many people have known for centuries in Eastern countries that there are many health benefits of bamboo, unlike the toxic metal and plastic materials.

Experimentally it has been found that the ultimate tensile strength of some species of bamboo is comparable to that of mild steel and it varies from 140 N/mm²-280 N/mm². This together with other properties has made Bamboo a suitable material for use in the hanger support arms according to the present invention. Compared to most wood species, bamboo provides a high strength to weight ratio and thus a hanger that is strong but light may be constructed. Some typical specific properties of Bamboo are as given below:

| Specific gravity | 0.575 to 0.655 | |
|---|---|---|
| Average weight | 0.625 | kg/m |
| Modulus of rupture | 610 to 1600 | kg/cm2 |
| Modulus of Elasticity | 1.5 to 2.0 × 105 | kg/cm2 |
| Ultimate compressive stress | 794 to 864 | kg/cm2 |
| Safe working stress in compression | 105 | kg/cm2 |
| Safe working stress in tension | 160 to 350 | kg/cm2 |
| Safe working stress in shear | 115 to 180 | kg/cm2 |
| Bond stress | 5.6 | kg/cm2 |

The important advantages which make Bamboo a more suitable material for use in the hangers according to the present invention are: It is economical and helps achieve cost effective construction, Bamboo is a fast growing species and it is a renewable resource which can be cultivated in most types of soil. The designs of the components being simple, there is no need of highly skilled labor. Its light weight and compact provides many benefits to commercial users during storage and transport of hangers in large scales. The dependency on the natural forests for wood will be reduced thus contributing to the protection of the environment. As it can grow in many types of soil, bamboo cultivation is suitable for rehabilitation of degraded forests and other waste lands thus converting them into fertile lands to some extent. The toxic air fumes emitted during the manufacturing stage of metal and plastic hangers can be eliminated from the environment. Some metal hangers manufactured in oversea may have some lead substance, which would come off over time, especially when the metal hanger is subject to moisture during storage in a residential closet.

While the invention has been described in connection with a presently preferred embodiment thereof, those skilled in the art will recognize that many modifications and changes can be made without departing from the true spirit and scope of the invention, which accordingly is intended to be defined solely by the appended claims.

1. A garment hanger comprising a hook attached to a central region of a support arm, wherein said support arm is a section of bamboo having a substantially circular shape and having a first end and a second end, and said support arm further comprising a bend, and wherein the bend has a predetermined angle.

2. The garment hanger according to claim 1, wherein the slope of said bend is within a range of 20-35 degrees.

3. The garment hanger according to claim 2, wherein the slope of said bend is 20 degrees.

4. The garment hanger according to claim 2, wherein the slope of said bend portion is within a range of 30-35 degrees.

5. The garment hanger according to claim 1, wherein said bend has a constant radius curve.

6. The garment hanger according to claim 1, wherein said bend is an increasing radius curve.

7. The garment hanger according to claim 1, wherein said bend is a decreasing radius curve.

8. The garment hanger according to claim 1, wherein said support arm has a constant cross section diameter from said first end to said second end.

9. The garment hanger according to claim 1, wherein said support arm has a tapered cross section diameter approaching said first end and said second end.

10. The garment hanger according to claim 1, wherein said hook is a bent wire attached to said central region through holes in said support arm structure with tabs.

11. The garment hanger according to claim 1, further comprising a support structure attached between said first end and said second end.

12. The garment hanger according to claim 1, further comprising a tubular cover supported by both ends of said support arm.

13. The garment hanger according to claim 1, further comprising a support material at both ends thereof.

14. A method for making a garment hanger, the method comprising:
providing a section of bamboo;
applying heat to said section of bamboo to shape said section of bamboo to a predetermined angle;
allowing said section of bamboo to cool; and
attaching a hook to said section of bamboo, wherein heating said section of bamboo includes heating the section of bamboo to a temperature of 752 to 1472 degrees Fahrenheit.

15. (canceled)

16. (canceled)

17. The method for making a garment hanger according to claim 14, wherein bending said section of bamboo to a predetermined angle includes applying a bending force for 20 seconds.

18. The method for making a garment hanger according to claim 14, wherein bending said section of bamboo to a predetermined angle includes heating the section of bamboo to a temperature within the range of 752 to 1472 degrees Fahrenheit for 15-20 seconds.

19. The method for making a garment hanger according to claim 14, wherein bending said section of bamboo to a predetermined angle includes bending to an angle within a range of 20-35 degrees.

20. The method for making a garment hanger according to claim 14, wherein attaching a hook to said section of bamboo comprises bending a wire having a first end and a second end to form a hook at a first end and inserting said second end into holes in said bamboo section and bending tabs in said second end to retain said hook within said holes.

21. The method for making a garment hanger according to claim 14, wherein bending said section of bamboo to a predetermined angle includes bending to a constant angle from a first end to a second end of said section of bamboo.

22. The method for making a garment hanger according to claim 14, wherein bending said section of bamboo to a predetermined angle includes bending said section of bamboo to a varying angle from a first end to a second end of said section of bamboo.

23. The method of making a garment hanger according to claim 14, wherein the section of bamboo is inserted into a mold having an opening for the heating.

24. The garment hanger according to claim 1, wherein said section of bamboo is heated to a temperature of 752 to 1472 degrees Fahrenheit to form the bend at the predetermined angle.
